(19) United States
(12) Patent Application Publication
(10) Pub. No.: US 2026/0101012 A1
(43) Pub. Date: Apr. 9, 2026

(54) STORAGE MEDIUM STORING PROGRAM WORKING WITH GENERAL-PURPOSE SCANNING SOFTWARE, METHOD AND INFORMATION PROCESSING APPARATUS

(71) Applicant: CANON KABUSHIKI KAISHA, Tokyo (JP)

(72) Inventor: JUN ITOH, Chiba (JP)

(21) Appl. No.: 19/347,577

(22) Filed: Oct. 1, 2025

(30) Foreign Application Priority Data
Oct. 3, 2024 (JP) 2024-174485

(51) Int. Cl. H04N 1/00

(52) U.S. Cl. CPC H04N 1/00811; H04N 1/00482

(57) ABSTRACT

A non-transitory computer-readable storage medium storing a program working with general-purpose scanning software commonly available in image reading apparatuses provided by a plurality of manufacturers, when executed by a computer, the program causes an information processing apparatus to perform a method includes displaying an object that receives a setting of creating image data in which a ground color of a document has been removed, and outputting a reading instruction to the image reading apparatus that executes scanning, based on the setting received by the object

### BACKGROUND

### Field of the Technology

The present disclosure relates to a storage medium that stores a program working with general-purpose scanning software, a method, and an information processing apparatus.

### Description of the Related Art

There is known a configuration in which a scanning driver installed in a host computer as control software of a scanning device is used to issue a scanning instruction to the scanning device connected to the host computer. An operating system (OS), which is basic software, is installed in the host computer, and the scanning driver is configured in accordance with specifications defined by the OS, and is called by the OS to operate. A vendor (manufacturer) that provides the scanning device can provide a means for instructing the scanning device to perform scanning using the OS by providing a scanning driver that conforms to the specifications of the OS.

In recent years, in Windows^{®}, a standard class driver (hereinafter, also referred to as a “standard driver”) commonly available in scanning devices provided by a plurality of vendors tends to be provided. The standard driver like this is packaged in an OS package, and can be easily used by connecting an arbitrary scanning device to a host computer. Therefore, it is not necessary to separately install a scanning driver specific to the model suitable for the scanning device, and convenience is high. Further, it is assumed that the standard driver is configured to be able to specify a scanning function according to scanning function information generated based on information acquired from a connected scanning device. As a result, a user who uses the standard driver can specify the scanning function according to a capability of the connected scanning device even though the user uses one standard driver. However, since this is only a function that can be realized only by the standard driver, a unique function of the vendor (manufacturer) of the scanning device cannot be specified.

Therefore, Japanese Patent Laid-Open No. 2021-033526 discloses a program for extending a printing function of general-purpose software.

An example of a vendor-specific function of a scanning driver is a background adjustment function.

The background adjustment function is a function of removing an image whose concentration is set as a ground so that a color (ground color) of a ground of a document is not scanned. In the background adjustment function, in addition to a function of manually setting the concentration of the image to be removed as the ground, there is an automatic adjustment function of automatically detecting the concentration of the ground from a scanned image and removing it. By using this function, a user can acquire image data from which the ground (ground color) of the document has been removed.

### SUMMARY

In view of the above, an information processing apparatus according to one aspect of the present disclosure includes the following configuration.

A non-transitory computer-readable storage medium storing a program working with general-purpose scanning software commonly available in image reading apparatuses provided by a plurality of manufacturers, when executed by a computer, the program causes an information processing apparatus to perform a method includes displaying an object that receives a setting of creating image data in which a ground color of a document has been removed, and outputting a reading instruction to the image reading apparatus that executes scanning, based on the setting received by the object0.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of a scanning system according to embodiments.

FIG. 2A is a software configuration diagram of the scanning system according to the embodiments.

FIG. 2B is a software configuration diagram of the scanning system according to the embodiments.

FIG. 3A is a diagram showing a scanning setting screen according to an embodiment 1.

FIG. 3B is a diagram showing a detailed setting screen according to the embodiment 1.

FIG. 3C is a diagram showing a detailed setting screen according to the embodiment 1.

FIG. 3D is a diagram showing a detailed setting screen according to the embodiment 1.

FIG. 3E is a diagram showing a detailed setting screen according to the embodiment 1.

FIG. 4 is a flowchart of a scanning function information editing process performed by an extension application according to the embodiment1.

FIG. 5 is a diagram showing scanning function lists of each apparatus according to the embodiment 1.

FIG. 6 is a sequence diagram showing a scanning operation according to the embodiment 1.

FIG. 7 is a flowchart showing a scanning process in the extension application according to the embodiment 1.

FIG. 8 is a flowchart showing a scanning process performed by a scanning device according to the embodiment 1.

FIG. 9 is a flowchart showing an additional process of a background adjustment function of an extension application according to an embodiment 2.

FIG. 10 is a sequence diagram showing a scanning operation according to the embodiment 2.

FIG. 11 is a flowchart showing a scanning process in the extension application according to the embodiment 2.

FIG. 12 is a sequence diagram showing a scanning operation according to an embodiment 3.

FIG. 13 is a sequence diagram showing a scanning operation according to the embodiment 3.

FIG. 14 is a sequence diagram showing a scanning operation according to an embodiment 4.

FIG. 15 is a flowchart showing a scanning process in an extension application according to the embodiment 4.

### DESCRIPTION OF THE EMBODIMENTS

Hereinafter, embodiments of the present disclosure will be described in detail with reference to the accompanying drawings. Note that the following embodiments do not limit the present disclosure in the claims, and all combinations of features described in the embodiments are not necessarily essential to the solution of the present disclosure.

### Embodiment 1

### Hardware Configuration of Scanning System

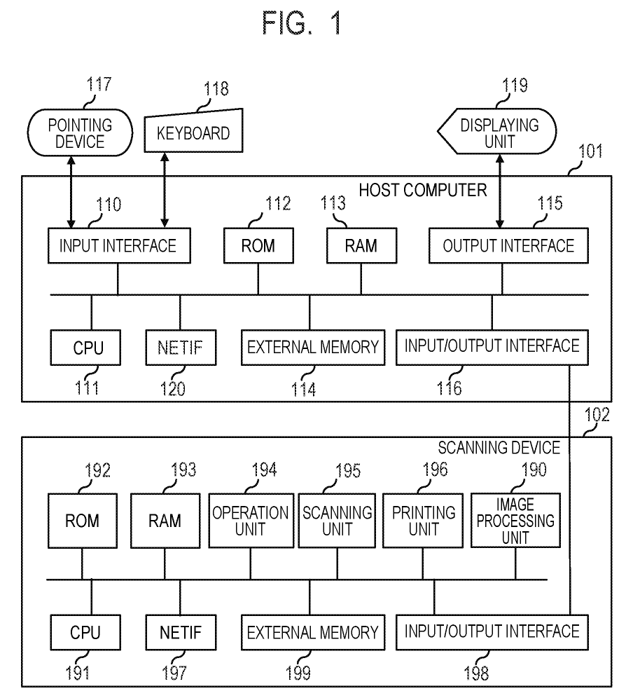

FIG. 1 is a block diagram showing a hardware configuration of a scanning system.

### Host Computer

In FIG. 1, a host computer 101 is an example of an information processing apparatus, and includes an input interface 110, a CPU 111, a ROM 112, a RAM 113, an external memory 114, an output interface 115, and an input/output interface 116. Inputting devices such as a keyboard 118, a pointing device 117 and the like are connected to the input interface 110, and a display device such as a displaying unit 119 is connected to the output interface 115. An NETIF 120 is a network interface, and performs control for performing data transfer with an external device via a network.

The ROM 112 stores an initialization program.

The external memory 114 is, for example, a hard disk drive (HDD) or a solid state drive (SSD). The external memory 114 stores application programs, an operating system (OS), and various other data.

The RAM 113 is used as a work memory or the like when executing various programs stored in the external memory 114, and the various programs can operate in the host computer 101.

In the present embodiment, the CPU 111 performs processes in accordance with codes of programs stored in the ROM 112, thereby executing later-described functions of the host computer 101 and processes according to later-described flowcharts.

### Scanning Device

A scanning device 102 is an example of an image reading apparatus, and is connected to the host computer 101 via an input/output interface 198 of the scanning device 102 and the input/output interface 116 of the host computer 101. The input/output interface 198 of the scanning device 102 and the input/output interface 116 of the host computer 101 may be a wired network or a wireless network.

The scanning device 102, which is the image reading apparatus, includes a CPU 191, a ROM 192, a RAM 193, an operation unit 194, a scanning unit 195, a printing unit 196, an NETIF 197, the input/output interface 198, and an external memory 199.

The CPU 191 comprehensively controls the scanning device 102.

The ROM 192 is a memory that stores programs.

The RAM 193 is a memory that temporarily stores programs and image data.

The scanning unit 195 is a scanner, and scans an image of a document.

The printing unit 196 prints an image on a sheet based on the image data. The printing unit 196 is not essential.

The NETIF 197 is a network interface, and performs control for performing data transfer with an external device via a network.

An image processing unit 190 performs various image editing processes for the input image data.

Here, the host computer 101 and the scanning device 102 are separately configured, but they may be configured as one information processing apparatus. A scanning setting screen and a detailed setting screen described later are displayed on the displaying unit 119. In the present embodiment, an electrophotographic digital multifunction peripheral having a plurality of functions such as copying, printing, and FAX will be described as an example of the scanning device. However, the present embodiment is not limited to this, and the present embodiment can also be applied to a device that uses another process such as an ink jet method, or to a scanner that performs only image scanning. The host computer 101 may be a desktop computer, a smartphone, or a notebook computer.

### (Software Configuration of Scanning System)

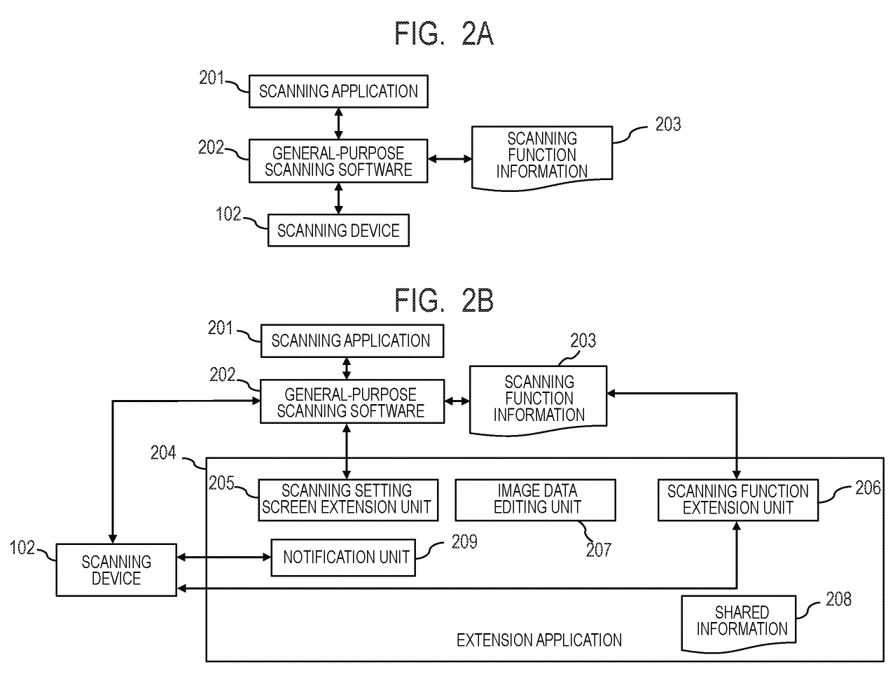

FIGS. 2A and 2B are diagrams schematically showing software configurations of the scanning system. The software configurations of FIGS. 2A and 2B are stored in the external memory 114 of FIG. 1. Here, a description will be given on the assumption of a scanning system using the host computer 101 equipped with Windows^{®}11 of Microsoft^{®} as the OS. Note that a standard driver is also provided in Apple MacOS^{®}, and the present technology can be applied thereto.

FIG. 2A is the diagram showing a general configuration in a case where an extension application 204 is not associated with general-purpose scanning software 202 and the scanning device 102.

FIG. 2B is the diagram showing a configuration in a case where the extension application 204 is associated with the general-purpose scanning software 202 and the scanning device 102.

### Software Configuration of Scanning System (Not Associated with Extension Application

First, with reference to FIG. 2A, a configuration of the scanning system in a case where the extension application 204 is not associated will be described.

A scanning application 201 is software for capturing scanned contents (image data). For example, this application corresponds to a document creation application or an image editing application. Upon receiving a scanning request from a user, the scanning application 201 issues a scanning instruction to the OS. The scanning instruction includes scanning setting information for instructing operations of the general-purpose scanning software 202 and the scanning device 102.

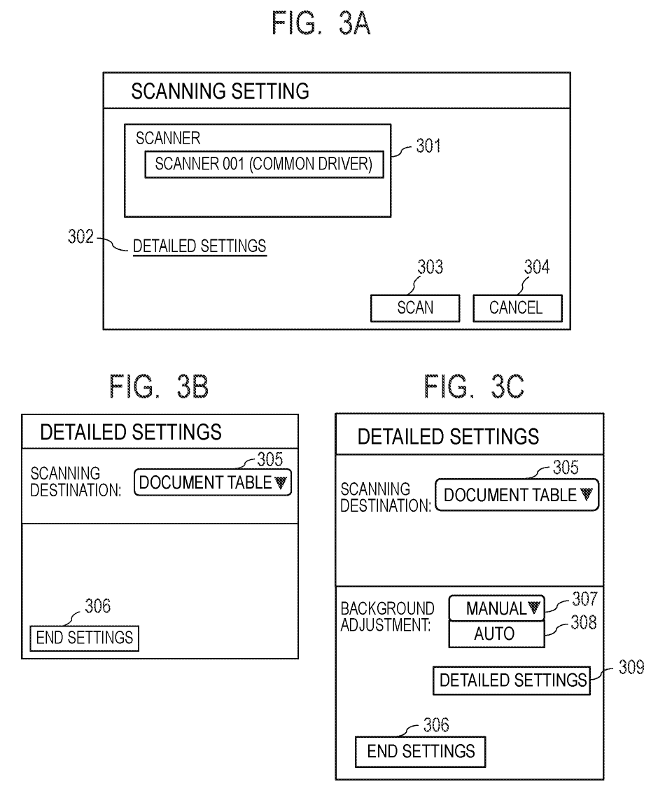

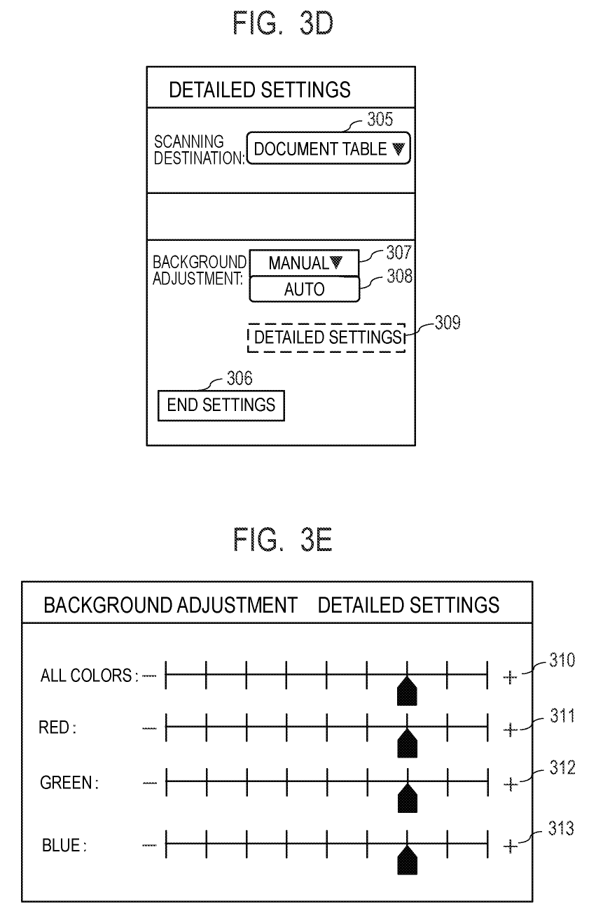

In order to execute the scanning instruction, the scanning application 201 can display a scanning setting screen provided by any of the general-purpose scanning software 202, the OS, and the scanning application 201. When a detailed setting in the scanning setting screen is pressed, the general-purpose scanning software 202 additionally displays the detailed setting screen. The scanning setting screen and the detailed setting screen will be described later with reference to FIGS. 3A to 3E. The detailed setting screen includes a setting item (hereinafter, also referred to as “a control item”) indicating a settable scanning function and a control item indicating a setting value thereof, according to scanning function information (settable information) of the general-purpose scanning software 202. The general-purpose scanning software 202 determines a scanning capability based on scanning function information 203.

The scanning function information 203 is data indicating all settable scanning functions, setting values thereof, and scanning functions in which exclusive relationships between the setting values are described. The scanning function information 203 is included in the configuration file of the general-purpose scanning software 202, and is arranged in the external memory 114 as an unchangeable file. Alternatively, the scanning function information 203 can be dynamically generated by the general-purpose scanning software 202. Specifically, the general-purpose scanning software 202 or the OS can be configured to acquire attribute data of the scanning device from the scanning device 102 and generate the scanning function information 203 according to attribute information in the acquired attribute data. When the scanning function information 203 is dynamically generated, the generated scanning function information 203 can be edited. The attribute data of the scanning device acquired from the scanning device 102 includes attribute information indicating a scanning function (capability of the scanning device) that can be specified by the scanning device 102 and a setting value related to the attribute information. This information is stored in the RAM 113.

With this configuration, the general-purpose scanning software 202 can be configured so that the user can specify the scanning function that can be used by each scanning device 102 according to the connected scanning device 102. That is, even when a scanning device having different functions or a scanning device developed by a different vendor is connected, the general-purpose scanning software 202 can be configured so that the user can specify the scanning function that can be used according to the connected scanning device. The general-purpose scanning software 202 can generate the scanning instruction that can be interpreted by a plurality of scanning devices manufactured by different vendors, and output the scanning instruction to each of the plurality of scanning devices manufactured by different vendors. The vendor may be a manufacturer of the scanning device 102. Here, the general-purpose scanning software 202 is a standard class driver that executes scanning based on a standard scanning protocol called “Mopria”. The general-purpose scanning software 202 acquires capability information of the connected scanning device 102 so that the user can specify the scanning function supported by the connected scanning device 102, and generates the scanning function information 203 based on the acquired information. The general-purpose scanning software 202 acquires the scanning function information 203 from the scanning device 102 by IPP (Internet Printing Protocol), and receives the image data generated by scanning the document by the scanning device 102. However, the general-purpose scanning software 202 does not support a background adjustment function. This is because the background adjustment function is a unique function of a vendor (a manufacturer of the scanning device) of the scanning device.

### Background Adjustment Function

The background adjustment function is a function of removing an image (ground color) having a concentration set as a ground so that a color (ground color) of the ground of a document is not scanned. As for ground setting, in addition to setting the same concentration for all colors, it is also possible to set a different concentration for each color of RGB (red, green, blue).

In the background adjustment function, in addition to a function of manually setting the concentration of the image to be removed as the ground, there is also an automatic adjustment function of automatically detecting the concentration of the ground from a scanned image and removing it.

In the present embodiment, an image process of removing the ground color is performed by an ASIC of the image processing unit 190, but the ground color removing process is not limited to this method, and the image process of removing the ground color may be performed by software, for example.

### (Software Configuration of Scanning System (Associated with Extension Application))

Next, with reference to FIG. 2B, a configuration of the scanning system in a case where the extension application 204 is associated will be described. Note that description of the same configurations as those in FIG. 2A will be omitted.

The extension application 204 is software for extending or supporting the functions of the general-purpose scanning software 202, and is also called a support application. The extension application 204 is software that is not included in the OS in advance (not packaged). Therefore, it is necessary for the user to operate the host computer 101 to download and install the extension application 204 from the server via the Internet. Alternatively, it may be automatically installed based on the fact that the scanning device 102 is connected to the host computer 101. Specifically, when the scanning device 102 is connected to the host computer 101, the OS acquires device discrimination information from the scanning device 102. The OS may download and install the extension application 204 corresponding to the acquired device discrimination information from the server via the Internet. That is, the general-purpose scanning software 202 and the extension application 204 are held in the host computer 101 as separate files.

Although the general-purpose scanning software 202 and the extension application 204 may be updated and upgraded, the update processes are also performed at different timings. That is, the timing at which the general-purpose scanning software 202 is acquired by the host computer 101 is different from the timing at which the extension application 204 is acquired. Further, a trigger for acquiring the general-purpose scanning software 202 by the host computer 101 and a trigger for acquiring the extension application 204 are also different. When the extension application 204 is installed, the OS associates the extension application 204 with the general-purpose scanning software 202 and the scanning device 102.

The extension application 204 described in the present embodiment includes a scanning setting screen extension unit 205, a scanning function extension unit 206, an image data editing unit 207, and a notification unit 209. The extension application 204 also includes shared information 208 that can be commonly accessed by each unit. The state of the shared information 208 is a file stored in the external memory 114 or information stored in the RAM 113. The extension application 204 uses API (Application Program Interface) provided by the OS to write or read information to or from the shared information 208.

Note that the extension application 204 may end the operation every time the process of each unit ends. In this case, the OS activates the extension application 204 every time a request to use each unit is received.

Further, the extension application 204 may cancel the process in the process of each unit. When the process is canceled, a job being processed is deleted by the OS.

Upon receiving a scanning request from the user, the scanning application 201 issues the scanning instruction to the OS. Also under this configuration, the scanning application 201 can display the scanning setting screen as in the configuration of FIG. 2A. In this configuration, the detailed setting screen provided by the extension application 204 is displayed. Specifically, the detailed setting screen provided by the scanning setting screen extension unit 205 included in the extension application 204 is displayed. The scanning setting screen extension unit 205 can store detailed settings set by the user in the shared information 208.

The extension application 204 includes the image data editing unit 207. The image data editing unit 207 acquires the image data from the scanning device 102 and edits the acquired image data. The image data editing unit 207 acquires detailed setting information from the shared information 208, and performs image editing according to the detailed setting on the image data. The extension application 204 may be configured to acquire the image data acquired by the general-purpose scanning software 202 and perform the image editing according to the detailed settings on the image data.

Also, even in the configuration of FIG. 2B, there is a case where background adjustment setting is not performed by the user. In this case, as in the configuration of FIG. 2A, the general-purpose scanning software 202 may issue a scanning request instruction to the scanning device 102 without going through the extension application 204.

The extension application 204 includes the scanning function extension unit 206. The scanning function extension unit 206 can edit the scanning function information 203 generated by the general-purpose scanning software 202 or the OS. Thus, the scanning function extension unit 206 can add a function provided by the extension application 204. In addition, the scanning function extension unit 206 can add a function (background adjustment function) which is supported by the scanning device 102 but is not supported by the general-purpose scanning software 202, add an exclusive relationship between setting values of scanning functions, and the like. The OS activates the scanning function extension unit 206 when the extension application 204 is initially associated with the scanning device 102 and the general-purpose scanning software 202. Further, the OS may activate the scanning function extension unit 206 at another timing such as when the OS is activated.

The extension application 204 also includes the notification unit 209. The notification unit 209 can display a notification to the user in response to occurrence of an error in the scanning device 102. For example, when a scanning jam error occurs in the scanning device 102, the general-purpose scanning software 202 detects the occurrence of the scanning jam error, and the OS causes the displaying unit 119 to display a message using a notification function called a toast notification, which is a function of the OS. When the user presses the toast notification, the notification unit 209 of the extension application 204 is called by the OS, and a UI screen of the notification unit 209 is displayed. On the UI screen of the notification unit 209, for example, a detailed message of a scanning jam error or a jam release method can be displayed.

The configuration of the extension application 204 for realizing the present embodiment is not limited to a configuration having all of the above-described functions (units), and may be a configuration having only a part of the functions or a configuration having other functions. The extension application 204 may be simply referred to as scanning software. As described above, it can be said that the extension application 204 includes at least one of the following functions.

• The first function is to display the setting screen (scanning setting screen extension unit 205).

• The second function is to edit the image data according to the detailed setting (image data editing unit 207).

• The third function is to extend the function that can be specified by image data generation software (scanning function extension unit 206).

• The fourth function is to display the screen in response to the occurrence of the error in the scanning device 102 (notification unit 209).

### Setting Screen

Next, an example of the scanning setting screen and the detailed setting screens according to the present embodiment will be described with reference to FIGS. 3A to 3E.

FIG. 3A is the diagram showing the scanning setting screen displayed by the scanning application 201.

FIG. 3B is the diagram showing the detailed setting screen displayed in a case where the extension application 204 shown in FIG. 2A is not provided.

FIG. 3C is the diagram showing the detailed setting screen displayed in a case where the extension application 204 shown in FIG. 2B is provided.

The units and modules for displaying the scanning setting screen are not limited to those described above.

For example, the scanning setting screen extension unit 205 may be configured to generate only a display screen. In this case, the scanning setting screen extension unit 205 transmits the generated display screen to the scanning application 201 via the general-purpose scanning software 202. The scanning application 201 may be configured to display the acquired display screen.

### Scanning Setting Screen Scanning Application

First, the scanning setting screen displayed by the scanning application 201 of FIG. 3A will be described.

A control 301 includes objects for allowing the user to set a scanner (scanner used for scanning) to which the image data is scanned.

A control 302 is a detailed setting button, and when the control 302 is pressed, an additional scanning screen is displayed by the general-purpose scanning software 202 or the scanning setting screen extension unit 205.

A control 303 is a scanning start button, and a control 304 is a scanning cancel button.

### Detailed Setting Screen General-Purpose Scanning Software

Next, FIG. 3B will be described. FIG. 3B is the diagram showing an additional setting screen displayed by the general-purpose scanning software 202 when the extension application 204 is not provided.

A control 305 indicates that a scanning destination can be set and a document table is selected.

A control 306 is a setting end button, and when the control 306 is pressed, the screen returns to the scanning setting screen of FIG. 3A.

### <Scanning Setting Screen (Scanning Setting Screen Extension Unit)>

Next, FIGS. 3C to 3E will be described. FIGS. 3C to 3E are the diagrams respectively showing additional setting screens displayed by the scanning setting screen extension unit 205 when the extension application 204 is provided, and FIG. 3C will be described first. Unlike FIG. 3B, a control 307 and a list 308 are added.

The control 307 and the list 308 is buttons (objects) that can select the background adjustment setting, and manual adjustment or automatic adjustment can be selected. Here, the manual adjustment is selected. When the manual adjustment is selected as the background adjustment setting, a control 309, which is an object for displaying the detailed setting screen, is added.

When the user selects the control 309, FIG. 3E of the detailed setting screen of the background adjustment function is displayed.

In the detailed setting of FIG. 3E, the concentration of the image to be removed as the ground color can be set. Slide bars 310 to 313 are displayed, and in this embodiment, the user can set the concentration of the ground color from 9 levels. The slide bar 310 is an item for setting the ground color concentration common to all colors. On the other hand, the slide bars 311 to 313, which are objects, are items for setting the ground color concentrations different for respective colors of RGB (red, green, blue). In the present embodiment, an example in which the ground color concentration can be set to each color of RGB is shown, but the settable colors may be other combinations such as CMYK (cyan, magenta, yellow, black) and the like.

FIG. 3D shows a case where the automatic adjustment is selected in the control 307 and the list 308.

In this case, since the user does not need to set the ground color concentration, the control 309 displaying the detailed setting screen is added in a state that the user cannot select it.

Here, the reason why the scanning setting items are different between FIG. 3B and FIGS. 3C to 3E will be described.

The detailed setting screen is generated by referring to the scanning capability generated based on the scanning function information. However, since the general-purpose scanning software 202 does not support the background adjustment function, the background adjustment function cannot be added to the scanning function information. Further, even when the background adjustment function is originally included in the scanning function information, the general-purpose scanning software 202 cannot interpret the background adjustment function included in the scanning function information, so that the background adjustment setting cannot be displayed on the detailed setting screen. However, the scanning function extension unit 206 is configured to add the background adjustment function to the scanning function information 203, and the scanning setting screen extension unit 205 is configured to display the detailed setting screen by referring to the scanning capability. With these configurations, the extension application 204 can display the background adjustment setting on the detailed setting screen. FIGS. 3C to 3E may additionally include an extension function other than the background adjustment function.

### Scanning Function Information Editing Process: Scanning Function Extension Unit

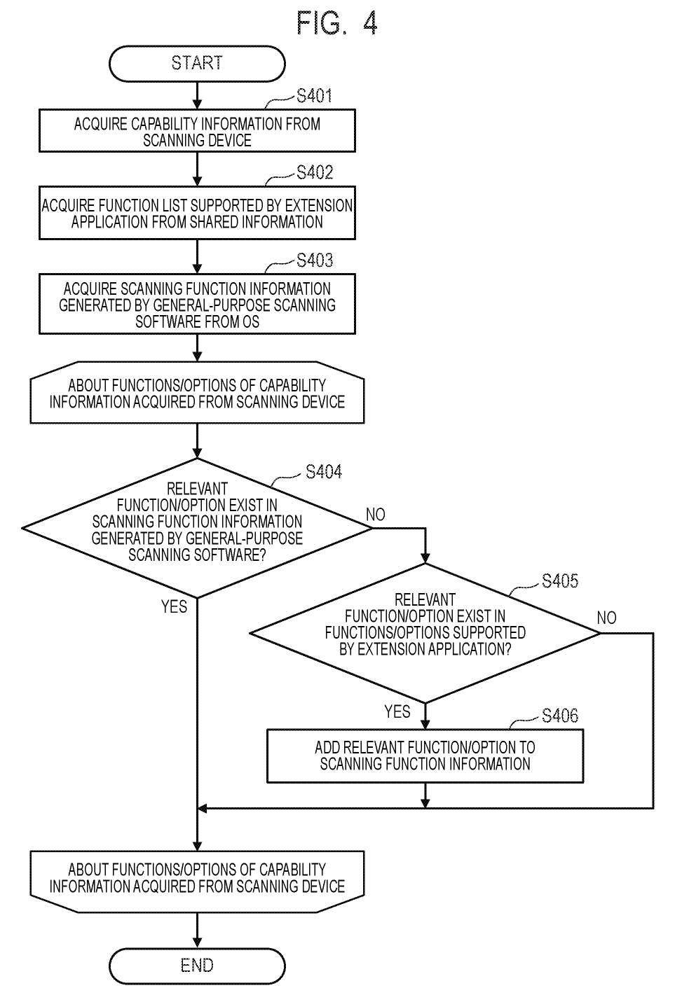

Here, a processing flow in which the scanning function extension unit 206 edits the scanning function information 203 will be described with reference to FIG. 4. Each step in the flow is realized by the CPU 111 executing each unit read from the external memory 114 to the RAM 113.

In S401, the scanning function extension unit 206 acquires the capability information from the scanning device 102, which is the image reading apparatus. The capability information is attribute information indicating the function that can be specified by the scanning device 102 and a setting value related to the attribute information.

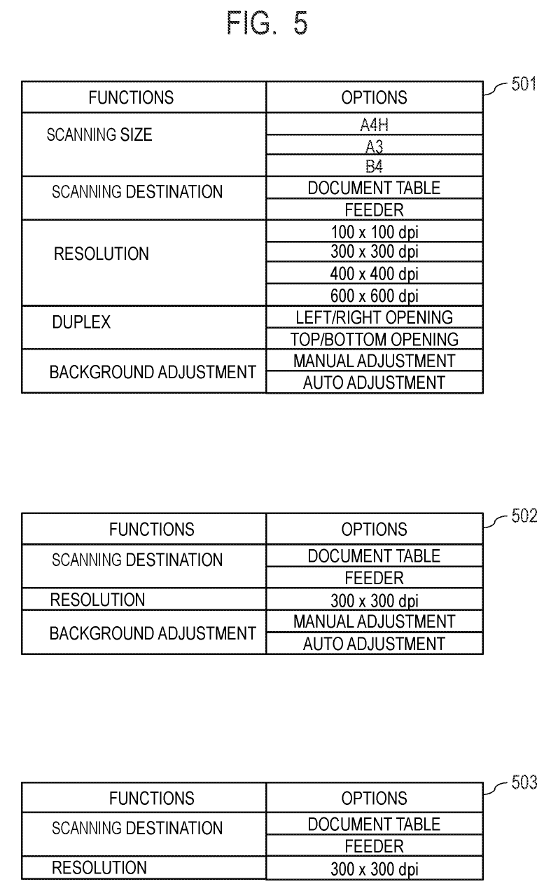

A table 501 in FIG. 5 shows an example of a list of the capability information acquired from the scanning device 102. As shown in the table 501, the functions such as scanning size specifying and the like, and options that can be set for the respective functions can be acquired from the scanning device 102.

In S402, the scanning function extension unit 206 acquires a scanning function list supported by the extension application 204 from the shared information 208. The scanning function list supported by the extension application 204 is stored in the shared information 208, and all scanning functions that can be processed by the extension application 204 and setting values thereof are described. A table 502 in FIG. 5 shows an example of the scanning function list supported by the extension application 204. The scanning function list supported by the extension application 204 may be updated by updating the extension application 204.

In S403, the scanning function extension unit 206 acquires the scanning function information 203, which is created by the general-purpose scanning software 202 from the OS. A table 503 in FIG. 5 shows an example of the scanning function list supported by the general-purpose scanning software 202. The scanning function information 203 created by the general-purpose scanning software 202 is created based on the capability information (table 501) acquired from the scanning device 102 by the general-purpose scanning software 202.

Since the scanning function information created by the general-purpose scanning software 202 includes only the scanning function supported by the general-purpose scanning software 202 among the capability information acquired from the scanning device 102, the function of the scanning function information is limited. For example, although the capability information (table 501 in FIG. 5) acquired from the scanning device 102 includes the background adjustment function, the general-purpose scanning software 202 does not support the background adjustment function, and the background adjustment function is not described in the scanning function information. By the scanning function extension unit 206 adding functions and options to the scanning function information, the extension application 204 can compensate for lack of functions of the general-purpose scanning software 202. The scanning function extension unit 206 can also delete unnecessary functions and options from the scanning function information created by the general-purpose scanning software 202.

Subsequent S404, S405, and S406 are processes repeatedly performed on the function list of the capability information acquired from the scanning device in S401. In the present embodiment, these processes are the processes that are repeatedly performed for 13 types of “scanning size: A4H to background adjustment: auto adjustment” included in the table 501.

In S404, the scanning function extension unit 206 determines whether or not the function/option being processed exists in the scanning function information 203 generated by the general-purpose scanning software 202.

When the function/option being processed exists in the scanning function information 203 (YES in S404), the process returns to the beginning of the loop process. Specifically, the next item is selected from among the functions/options of the scanning function acquired from the scanning device 102, and the process of S404 is performed again. When the last item among the functions/options included in the capability information acquired from the scanning device 102 is being processed, the process loops out and the flowchart of FIG. 4 ends. When the function/option being processed does not exist in the scanning function information 203 (NO in S404), the process advances to S405. In the present embodiment, for example, since “scanning destination: document table” of the table 501, which is the scanning function of the scanning device 102, also exists in the table 503 which is the scanning function of the general-purpose scanning software 202, YES is determined in S404. On the other hand, since “scanning size: A4H” shown in the table 501 does not exist in the table 503, NO is determined, and the process advances to S405.

In S405, the scanning function extension unit 206 determines whether or not the function/option being processed exists among the functions/options supported by the extension application 204. When it is determined that the function/option being processed exists (YES in S405), the process advances to S406. When it is determined that the function/option being processed does not exist (NO in S405), the process of S404 is performed again as in the case where YES is determined in S404, or the process loops out and the process of this flowchart ends. In the present embodiment, for example, in a case where the function being processed is “background adjustment: manual adjustment”, since the function also exists in the table 502 which is the capability information of the extension application 204, YES is determined in S405, and the process advances to S406.

In S406, the scanning function extension unit 206 adds the function/option being processed to the scanning function information 203. After the process in S406, the process in S404 is performed again in the same manner as in the case where YES is determined in S404, or the process loops out and the process of this flowchart ends.

As described above, the scanning function extension unit 206 adds, to the scanning function information 203, the function/option that is not supported by the general-purpose scanning software 202, is supported by the scanning device 102, and is supported by the extension application 204. The scanning capability is generated based on the scanning function information edited by this process. Further, the scanning setting screen extension unit 205 generates a display screen based on the generated scanning capability, thereby extending the functions that are not supported by the general-purpose scanning software 202 and displaying the detailed setting screen shown in FIG. 3C.

### Sequence of Scanning Process

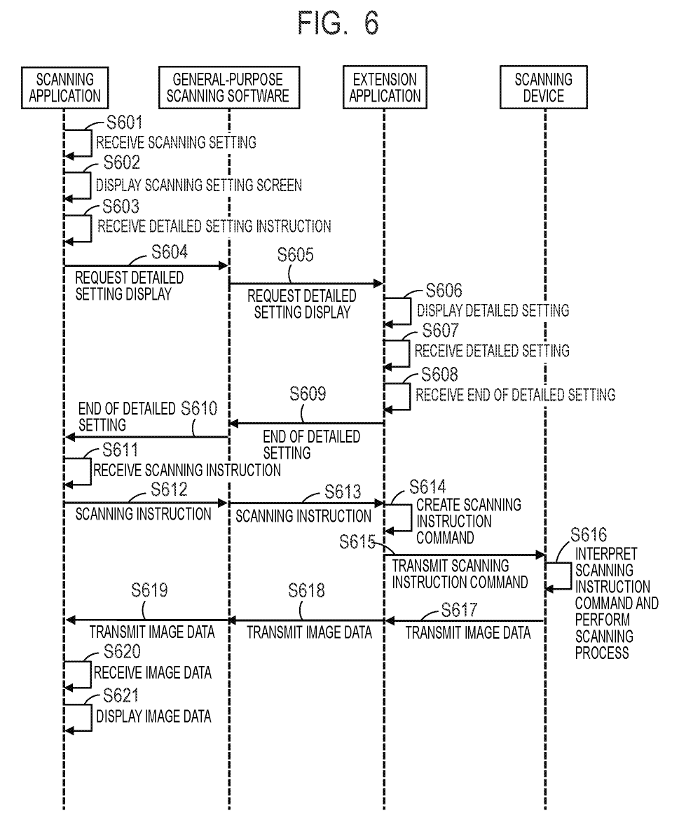

A sequence of the scanning application 201, the general-purpose scanning software 202, the extension application 204, and the scanning device 102 after the scanning application 201 receives the scanning setting will be described with reference to FIG. 6. Each step other than the scanning device 102 in FIG. 6 is performed by the CPU 111 reading the scanning application 201, the general-purpose scanning software 202, and the extension application 204 from the external memory 114 to the RAM 113 and executing them. Each step of the scanning device 102 in FIG. 6 is realized by the CPU 191 of the scanning device 102 reading the program stored in the ROM 192 or the external memory 199 into the RAM 193 and executing the read program.

In S601, the scanning application 201 receives the scanning setting by the user.

The user can instruct the scanning setting to the scanning application 201 by operating the pointing device 117 or the keyboard 118.

In S602, the scanning application 201 displays the scanning setting screen shown in FIG. 3A on the displaying unit 119.

In S603, the scanning application 201 receives the detailed setting instruction. The user can instruct the detailed setting by operating the pointing device 117 or the keyboard 118 to select the control 302.

In S604, the scanning application 201 requests the general-purpose scanning software 202 to display the detailed setting.

In S605, the general-purpose scanning software 202 requests the extension application 204 to display the detailed setting.

In S606, the scanning setting screen extension unit 205 of the extension application 204 causes the displaying unit 119 to display the detailed setting screen shown in FIG. 3C. This is because, as described with reference to FIG. 4, the background adjustment setting is added to the scanning function information by the scanning function extension unit 206. The scanning setting screen extension unit 205 displays the detailed setting screen of FIG. 3C on the displaying unit 119 with reference to the scanning capability generated based on the added scanning function information. In the present embodiment, since the resolution supported by the extension application 204 is one kind of 300×300 dpi, it is not necessary for the user to select the resolution, and there is no display on the detailed setting screen. Even when not selectable, it may be configured to display it on the detailed setting screen to clearly indicate it to the user.

In S607, the scanning setting screen extension unit 205 receives the detailed setting. In the present embodiment, as shown in FIG. 3C, it is assumed that “scanning destination: document table”, and “background adjustment: manual adjustment” are selected by the user. The received setting is stored in the RAM 113 by the CPU 111.

In S608, the scanning setting screen extension unit 205 receives an end of the detailed setting, and instructs to write the received setting to the scanning setting information. The user can operate the pointing device 117 or the keyboard 118 to select the control 306 to instruct the end of the detailed setting. When writing the setting to the scanning setting information, it may be configured to also write an item such as a resolution which is not selected by the user.

In S609, the extension application 204 transmits the end of the detailed setting to the general-purpose scanning software 202.

In S610, the general-purpose scanning software 202 transmits the end of the detailed setting to the scanning application 201.

In S611, the scanning application 201 receives the scanning instruction. The user can instruct the scanning by operating the pointing device 117 or the keyboard 118 to select the control 303.

In S612, the scanning application 201 issues the scanning instruction to the general-purpose scanning software 202.

In S613, the general-purpose scanning software 202 issues the scanning instruction to the extension application 204.

In S614, the extension application 204 creates a scanning instruction command based on the scanning setting information written in S608. In S608, in a case where an item that is not selected by the user such as a resolution is not written in the scanning setting information, the extension application 204 may add the item at the time of creating the scanning instruction command in S614. In addition, a configuration may be adopted in which the scanning device 102 operates with a default value without any adding.

In S615, the extension application 204 transmits the scanning instruction command to the scanning device 102 to issue the scanning instruction.

In S616, the scanning device 102 interprets the scanning instruction command and executes the scanning.

At the time of the scanning execution, a necessary image process according to the scanning instruction is performed on the image data.

In the present embodiment, when the scanning setting (background adjustment: manual adjustment) shown in FIG. 3C is performed, a scanning process of performing a background adjustment process is performed. That is, the image data in which a ground color removing process with the set concentration has been performed is generated.

In S617, the scanning device 102 transmits the generated image data to the extension application 204.

In S618, the extension application 204 transmits the received image data to the general-purpose scanning software 202.

In S619, the general-purpose scanning software 202 transmits the received image data to the scanning application 201.

In S620, the scanning application 201 receives the image data.

In S621, the scanning application 201 displays the received image data, and ends the process.

### [Scanning Process: Extension Application]

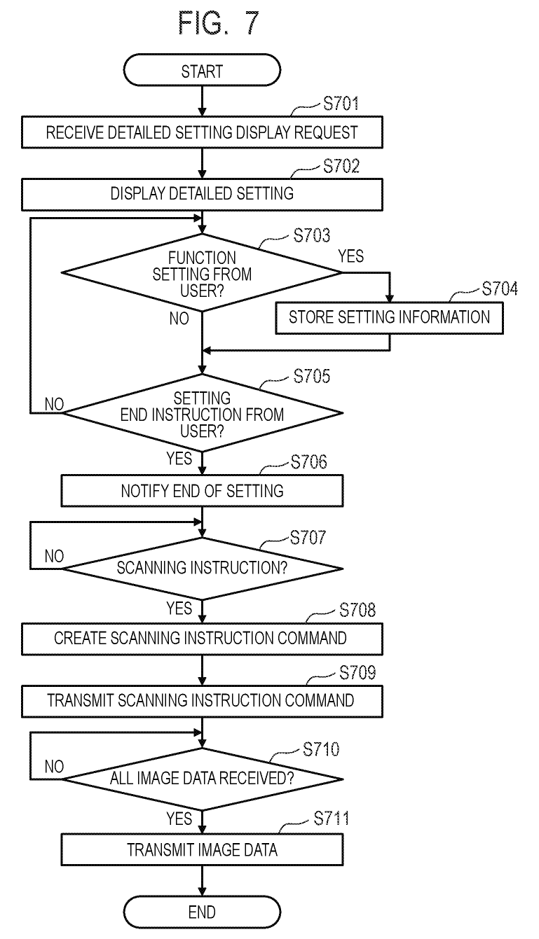

Here, a flow in which the extension application 204 executes the scanning process will be described with reference to FIG. 7. Each step in this flow is realized by the CPU 111 executing each unit read from the external memory 114 to the RAM 113.

In S701, the extension application 204 receives a detailed setting display request.

In S702, the scanning setting screen extension unit 205 of the extension application 204 causes the displaying unit 119 to display the detailed setting screen shown in FIG. 3C. This is because, as described with reference to FIG. 4, the background adjustment setting is added to the scanning function information by the scanning function extension unit 206. The scanning setting screen extension unit 205 displays the detailed setting screen of FIG. 3C on the displaying unit 119 with reference to the scanning capability generated based on the added scanning function information 203.

In S703, the scanning setting screen extension unit 205 determines whether or not there is function setting from the user. When there is the function setting by the user (YES in S703), the CPU 111 advances the process to S704, and when there is no function setting (NO in S703), the CPU 111 advances the process to S705.

In S704, the detailed setting is received, the received settings are stored in the RAM 113 by the CPU 111, and the process advances to S705.

In S705, the scanning setting screen extension unit 205 determines whether or not there is a setting end instruction from the user. When there is the setting end instruction (YES in S705), the CPU 111 receives the end of the detailed setting, writes the received setting in the scanning setting information, and advances the process to S706. When there is no setting end instruction (NO in S705), the process returns to S703 to determine again whether or not there is the function setting from the user.

In S706, the extension application 204 transmits the end of the detailed setting to the general-purpose scanning software 202.

In S707, the extension application 204 determines whether or not there is the scanning instruction from the general-purpose scanning software 202. When there is the scanning instruction (YES in S706), the CPU 111 advances the process to S708, and when there is no scanning instruction (NO in S706), the process returns to S707 to determine again whether or not there is the scanning instruction from the general-purpose scanning software 202.

In S708, the extension application 204 creates the scanning instruction command based on the scanning setting information written in S705.

As a method of creating the scanning instruction command in S708, there is a method of extending a command of a standard protocol. As an extension method, there is a method of describing a dedicated command in an extension area of the command of the standard protocol. In addition, there are a method of adding a command of a unique standard to the end of the command of the standard protocol, a method of overwriting the command of the standard protocol with a unique command system by the extension application 204, and the like.

When the instruction is issued from the extension application 204, the instruction and communication may be performed using a protocol unique to the vendor (manufacturer) regardless of the standard protocol.

In S709, the extension application 204 transmits the scanning instruction command to the scanning device 102 to issue the scanning instruction.

In S710, the extension application 204 determines whether or not all image data have been received from the scanning device 102. When all the image data have been received (YES in S710), the CPU 111 advances the process to S711, and when not (NO in S710), the process returns to S710 to determine whether or not all the image data have been transmitted from the scanning device 102.

In S711, the extension application 204 transmits the received image data to the general-purpose scanning software 202.

### Scanning Process: Scanning Device

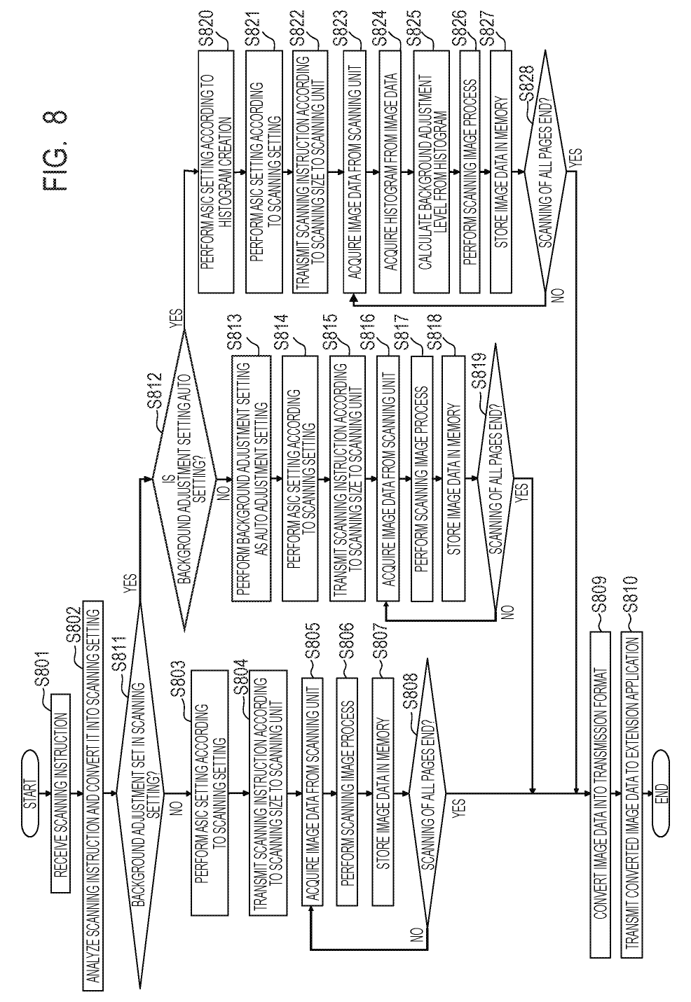

Next, a flow of the scanning process of the scanning device 102 that has received the scanning instruction from the extension application 204 will be described with reference to FIG. 8. Each operation (step) shown in the flowchart of FIG. 8 is realized by the CPU 191 executing the program stored in the RAM 192.

In S801, the CPU 191 receives the scanning instruction transmitted from the extension application 204.

In S802, the scanning instruction command received in S801 is analyzed, and the scanning instruction command is converted into a scanning setting that allows the scanning device 102 to perform a scanning process. In the present embodiment, the scanning setting is performed with “document table”, “background adjustment: manual adjustment”, and “resolution: 300×300 dpi”.

In S811, the CPU 191 determines whether or not the background adjustment is set in the scanning setting.

When it is determined that the background adjustment is not set (NO in S811), the process advances to S803, and when it is determined that the background adjustment is set (YES in S811), the process advances to S812.

In S803, the CPU 191 determines an ASIC of the image processing unit 190 to be used for performing scanning according to the scanning setting converted in S802, and performs ASIC setting.

In S804, the CPU 191 transmits a scanning instruction corresponding to the scanning setting to the scanning unit 195.

In S805, the CPU 191 acquires the image data from the scanning unit 195.

In S806, the CPU 191 and the image processing unit 190 perform an image process on the received image data. In the present embodiment, the conversion is performed to “resolution: 300×300 dpi”. When the scanning unit 195 is capable of scanning at 300×300 dpi, the scanning unit 195 may acquire the image data at 300×300 dpi, and the image process may not be performed in S806.

In S807, the CPU 191 stores the image data in the external memory 199.

In S808, the CPU 191 determines whether or not the scanning process for all pages has ended. When it is determined that the scanning process has not ended (NO in S808), the CPU 191 advances the process to S805, and executes the scanning process of the next page. When it is determined that the process has ended (YES in S808), the CPU 191 advances the process to S809.

In S809, the CPU 191 and the image processing unit 190 convert the image data stored in S807, in accordance with the transmission format setting received in S801. In the present embodiment, the transmission format is not included in the scanning instruction received from the extension application 204. For this reason, although the image data is converted into the default JPEG of the scanning device 102, the transmission format to be converted is not limited to this, and any format can be used as long as it can be handled by the information processing apparatus.

In S810, the converted image data is transmitted to the extension application 204, and all the processes ends.

In S812, the CPU 191 determines whether the background adjustment setting is the manual setting or the auto setting.

When the manual adjustment is determined (NO in S812), the process advances to S813, and when the automatic adjustment is determined (YES in S812), the process advances to S820.

### Manual Adjustment

In S813, the CPU 191 determines the ASIC of the image processing unit 190 to be used for performing the background adjustment process (ground color removing process) according to the scanning setting converted in S802, and performs the setting to the ASIC.

In S814, the CPU 191 determines the ASIC of the image processing unit 190 to be used for performing the scanning according to the scanning setting other than the background adjustment converted in S802, and performs the setting to the ASIC.

In S815, the CPU 191 transmits the scanning instruction according to the scanning setting to the scanning unit 195.

In S816, the CPU 191 acquires the image data from the scanning unit 195.

In S817, the CPU 191 and the image processing unit 190 perform the image process on the received image data. In the present embodiment, the process of converting to “resolution: 300×300 dpi” and the background adjustment process of removing the ground color with the ground color concentration of the scanning setting converted in S802.

In S818, the CPU 191 stores the image data in the external memory 199.

In S819, the CPU 191 determines whether or not the scanning process for all pages has ended. When it is determined that the process has not ended (NO in S819), the process advances to S816, and executes the scanning process of the next page. When it is determined that the process has ended (YES in S819), the process advances to S809.

### Auto Adjustment

In S820, the CPU 191 determines the ASIC of the image processing unit 190 to be used for generating a histogram of the image data when acquiring the image data from the scanning unit 195, and performs the setting to the ASIC.

In S821, the CPU 191 determines the ASIC of the image processing unit 190 to be used for performing the scanning according to the scanning setting converted in S802, and performs the setting to the ASIC.

In S822, the CPU 191 transmits the scanning instruction according to the scanning setting to the scanning unit 195.

In S823, the CPU 191 acquires the image data from the scanning unit 195.

In S824, the CPU 191 acquires the histogram of the image data generated by the ASIC of the image processing unit 190.

In S825, the CPU 191 calculates, from the acquired histogram, the ground color concentration of the image data acquired from the scanning unit 195 and calculates a background adjustment level.

In S826, the CPU 191 and the image processing unit 190 perform the image process on the received image data. In the present embodiment, the process of converting to “resolution: 300×300 dpi” and the background adjustment process of removing the ground color with the ground color concentration calculated in S825.

In S827, the CPU 191 stores the image data in the external memory 199.

In S828, the CPU 191 determines whether or not the scanning process for all pages has ended. When it is determined that the process has not ended (NO in S828), the process advances to S823, and executes the scanning process of the next page. When it is determined that the process has ended (YES in S828), the process advances to S809.

In the background adjustment (ground color removing) process of the present embodiment, the background adjustment process is realized by using the ASIC, but the background adjustment process may be realized by a software process, or may be realized by combining the ASIC and the software process.

As described above, in the present embodiment, the scanning setting screen extension unit 205 of the extension application 204 corrects the scanning function information 203 based on the general-purpose scanning software 202, the extension application 204, and the capability information of the scanning device 102. Further, when the detailed setting screen is requested from the user, the setting screen is displayed based on the scanning capability generated from the scanning function information 203, so that the user can set the background adjustment setting. After that, upon receiving the scanning instruction in which the background adjustment setting is reflected, the scanning device 102 performs the scanning by executing the background adjustment function. Through the above-described series of processes, the scanning device 102 can realize the background adjustment function, and can provide the user with the background adjustment function.

In the present embodiment, the detailed setting screens shown in FIGS. 3C to 3E are used in the configuration of FIG. 2B, but the present disclosure is not limited thereto. For example, when the detailed setting display request is made to the general-purpose scanning software 202 in S604, the general-purpose scanning software 202 may display the detailed setting screen shown in FIG. 3B. Subsequently, after completion of the detailed setting in FIG. 3B, the general-purpose scanning software 202 requests the extension application 204 to display an additional detailed setting screen. Next, the extension application 204 may additionally display the detailed setting screen on which the background adjustment can be set.

In addition, the scanning instruction to the extension application 204 is performed by the general-purpose scanning software 202, but the present disclosure is not limited thereto. For example, a method of giving an instruction from the scanning application 201 to the extension application 204 or a method of placing the scanning instruction control on the detailed setting screen and directly giving an instruction to the extension application 204 by the user may be employed. The image data may be directly transferred from the extension application 204 to the scanning application 201 without passing through the general-purpose scanning software 202, or may be transferred from the scanning device 102 to the scanning application 201. Alternatively, the received image data may be stored in the external memory 114, and only information of a file path as a storage destination may be transferred.

In the present embodiment, when there are a plurality of pieces of image data, all the pieces of image data are received and then transferred, but a method of transferring the transmitted image data as needed may be employed.

### Embodiment 2

Hereinafter, an embodiment 2 of the present disclosure will be described. In the embodiment 1, first, the scanning device 102 interprets the scanning setting information including the background adjustment, and the scanning device 102 performs the scanning process in the specified background adjustment function.

However, some scanning devices may not support the background adjustment function at all. In such a case, the user cannot use the background adjustment function.

Therefore, in the embodiment 2, first, it is determined whether or not the scanning device supports the background adjustment function from the capability information of the scanning device. Next, when the scanning device supports the background adjustment function, scanning setting information including the background adjustment function specified by the user is generated and transferred to the scanning device.

On the other hand, when the scanning device does not support the background adjustment function, the scanning setting information is generated without including the background adjustment setting, and is transferred to the scanning device. Then, the image data scanned by the scanning device is subjected to the background adjustment process. This makes it possible to provide the background adjustment function to the user even when the scanning device does not support the background adjustment function.

Only differences from the embodiment 1 will be described below.

It is assumed that the scanning device 102 does not support the background adjustment function. The configuration of the extension application 204 is different from that of the extension application 204 of the embodiment 1. The scanning function extension unit 206 adds the background adjustment function to the scanning function information 203 in a case where a unit of performing a background adjustment process on image data is included in the extension application 204. That is, even when the background adjustment function is not included in the capability information acquired from the scanning device, the background adjustment function is added to the scanning function information 203, and the background adjustment function can be used. The image data editing unit 207 performs the image background adjustment process on the image data received from the scanning device 102, based on the background adjustment function setting set by the user. Details thereof will be described later.

### [Scanning Function Information Editing Process: Scanning Function Extension Unit]

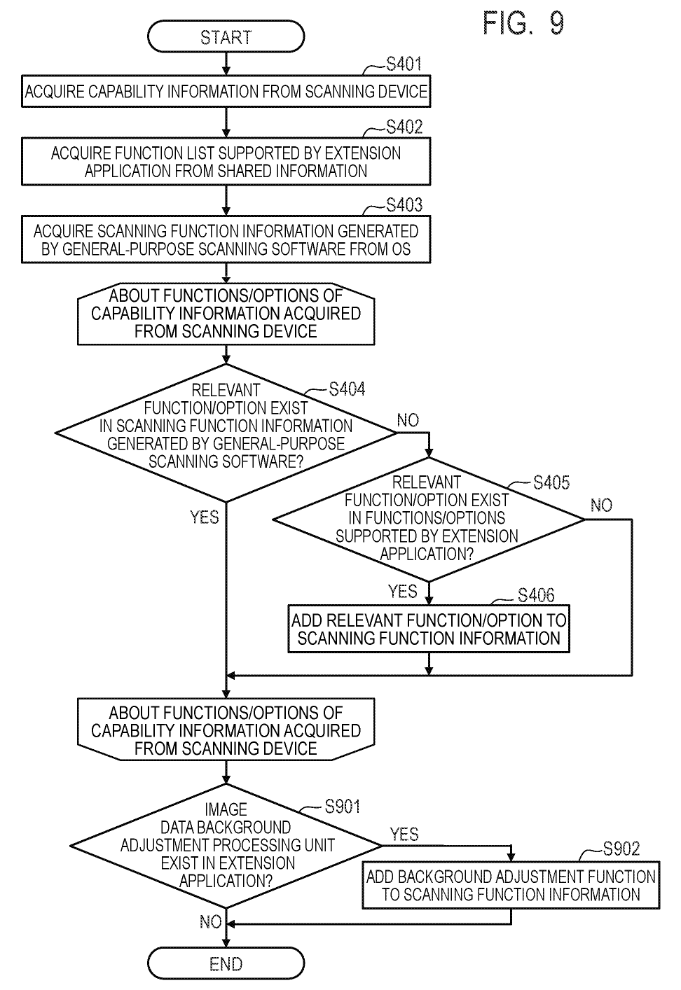

A scanning function information editing process performed by the scanning function extension unit 206 according to the embodiment 2 will be described with reference to FIG. 9. Steps common to those in FIG. 4 will be denoted by the same reference numerals respectively, description thereof will be omitted, and differences will be mainly described. Each step in FIG. 9 is realized by the CPU 111 executing each unit read from the external memory 114 to the RAM 113.

When the repetitive processes in S404 to S406 end, the scanning function extension unit 206 advances the process to S901. Here, the scanning device 102 does not support the background adjustment function. Therefore, the background adjustment function is not added to the scanning function information 203 after the end of the processes in S404 to S406.

Therefore, in S901 and S902, although not included in the capability information returned from the scanning device 102, a process for adding a function to the scanning function information is performed according to a module included in the extension application 204.

Specifically, in S901, the scanning function extension unit 206 refers to the capability table of the scanning device and the scanning function information 203, and determines whether or not there is a module for performing the background adjustment process in the extension application 204. When it is determined that there is the module that performs the background adjustment process (YES in S901), the process advances to S902, and when it is determined that there is no module (NO in S901), the process ends. In the embodiment 2, since the image data editing unit 207 can perform the background adjustment process, it is determined that the extension application 204 includes the module that performs the background adjustment process.

In S902, the scanning function extension unit 206 adds the background adjustment function to the scanning function information.

As described above, the scanning function extension unit 206 first adds, to the scanning function information 203, a function/option that is not supported by the general-purpose scanning software 202, is supported by the scanning device 102, and is supported by the extension application 204. After that, it is determined whether or not the background adjustment process can be performed by the extension application 204, and when the background adjustment function can be performed, the background adjustment function is added to the scanning function information. By this process, even when the scanning device 102 does not support the background adjustment function, it is possible to display the detailed setting screens shown in FIGS. 3B to 3E by generating the display screens based on the scanning function information 203 by the scanning setting screen extension unit 205.

### Sequence of Scanning Process

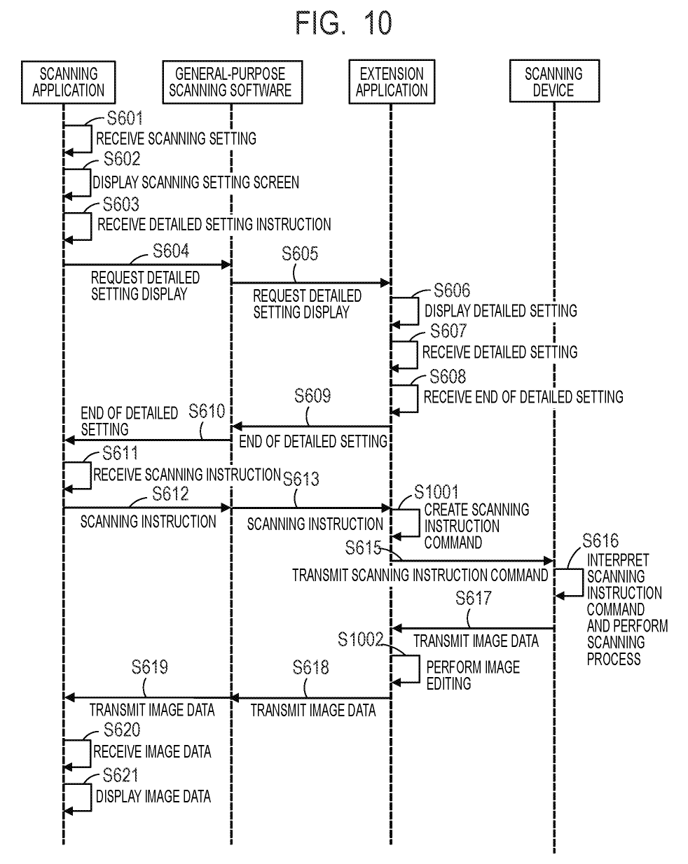

Next, a sequence of the scanning application 201, the general-purpose scanning software 202, the extension application 204, and the scanning device 102 after the scanning application 201 receives the scanning setting will be described with reference to FIG. 10. Each step other than the scanning device 102 in FIG. 10 is performed by the CPU 111 reading the scanning application 201, the general-purpose scanning software 202, and the extension application 204 from the external memory 114 to the RAM 113 and executing them. Each step of the scanning device 102 in FIG. 10 is realized by the CPU 191 of the scanning device 102 reading the program stored in the ROM 192 or the external memory 199 into the RAM 193 and executing the read program. Hereinafter, steps common to those in FIG. 6 will be denoted by the same reference numerals respectively, description thereof will be omitted, and differences will be mainly described.

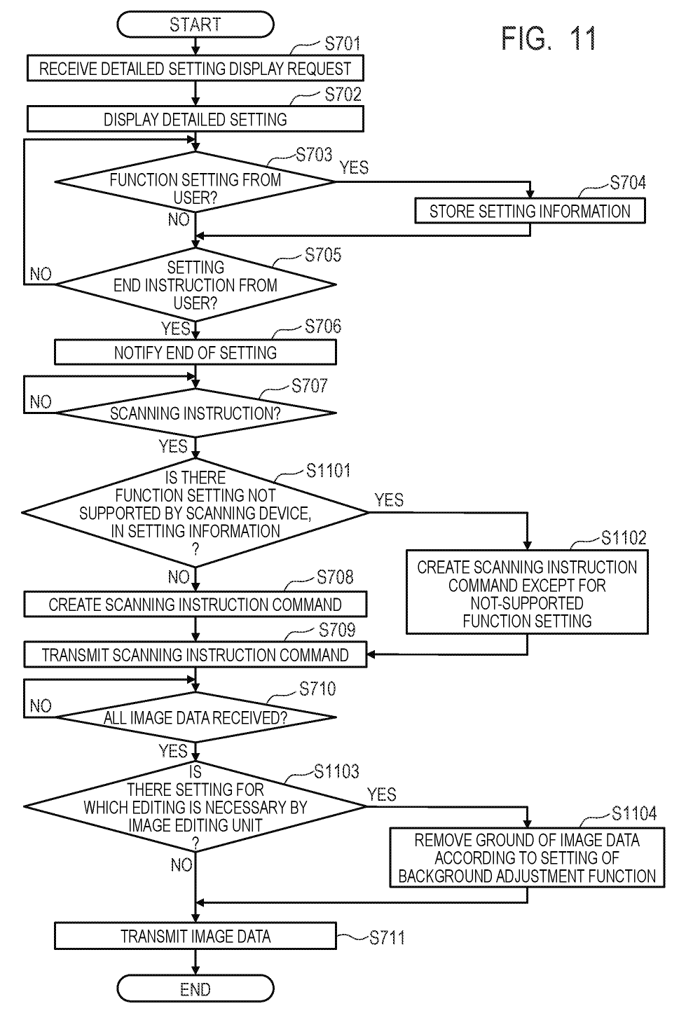

In S1001, the extension application 204 creates a scanning instruction command. At this time, the detailed movement will be described with reference to the flowchart of FIG. 11.

In S1002, the image data editing unit 207 performs the image editing on the received image data. In the present embodiment, the image process for removing the ground color is performed on the image data according to the background adjustment function setting.

Here, a flow in which the extension application 204 executes the scanning process will be described with reference to FIG. 11. Steps common to those in FIG. 7 will be denoted by the same reference numerals respectively, description thereof will be omitted, and differences will be mainly described. Each step is realized by the CPU 111 executing each unit read from the external memory 114 to the RAM 113.

### Scanning Process: Extension Application

In S1101, the extension application 204 acquires the capability information of the scanning device 102 from the shared information 208. When there is no capability information of the scanning device 102, the scanning function extension unit 206 may request the scanning device 102 to store the capability information in the shared information 208.

Based on the acquired capability information and the setting information, the extension application 204 determines whether or not there is a fixed size setting not supported by the scanning device 102.

When it is determined that a function not supported by the scanning device 102 is set (YES in S1101), the CPU 111 advances the process to S1102. In the embodiment 2, since the background adjustment function not supported by the scanning device 102 is set, the process advances to S1102. When it is determined that the function not supported by the scanning device 102 is not set (NO in S1101), the CPU 111 advances the process to S708.

Next, in S1102, the extension application 204 creates a scanning instruction command excluding unsupported function settings, and the process advances to S707. In the present embodiment, the background adjustment function is not included in the scanning instruction command.

A next process to be performed when it is determined in S710 that the previous image data has been received will be described.

In S1103, the extension application 204 determines from the setting information whether or not there is a setting that needs to be edited by the image data editing unit 207. When it is determined that there is a setting requiring editing (YES in S1103), the CPU 111 advances the process to S1104. In the embodiment 2, since the background adjustment function that cannot be executed by the scanning device 102 is set, the process advances to S1104. On the other hand, when it is determined that there is no setting requiring editing (NO in S1103), the CPU 111 advances the process to S711.

Next, in S1104, the image data editing unit 207 performs a ground color removing process on the received image data based on the background adjustment function setting set in S703.

In the present embodiment, the function setting that is not supported by the scanning device is excluded from the scanning instruction command. However, even when there is a description in the scanning instruction command, the scanning device cannot interpret the instruction command that is not supported and cannot execute the function.

Therefore, the function that is not supported may be described as it is without excluding this function from the scanning instruction command.

As described above, in the embodiment 2, even when the scanning device does not support the background adjustment function, the background adjustment function can be provided to the user.

### Embodiment 3

Hereinafter, an embodiment 3 of the present disclosure will be described. In the above embodiments 1 and 2, the extension application 204 and the scanning device 102 are configured to exchange data.

In the embodiment 3, the general-purpose scanning software 202 exchanges data with the scanning device 102, and the extension application 204 only extends scanning commands and edits images.

Hereinafter, only differences from the embodiments 1 and 2 will be described.

### Sequence of Scanning Process Command Extension

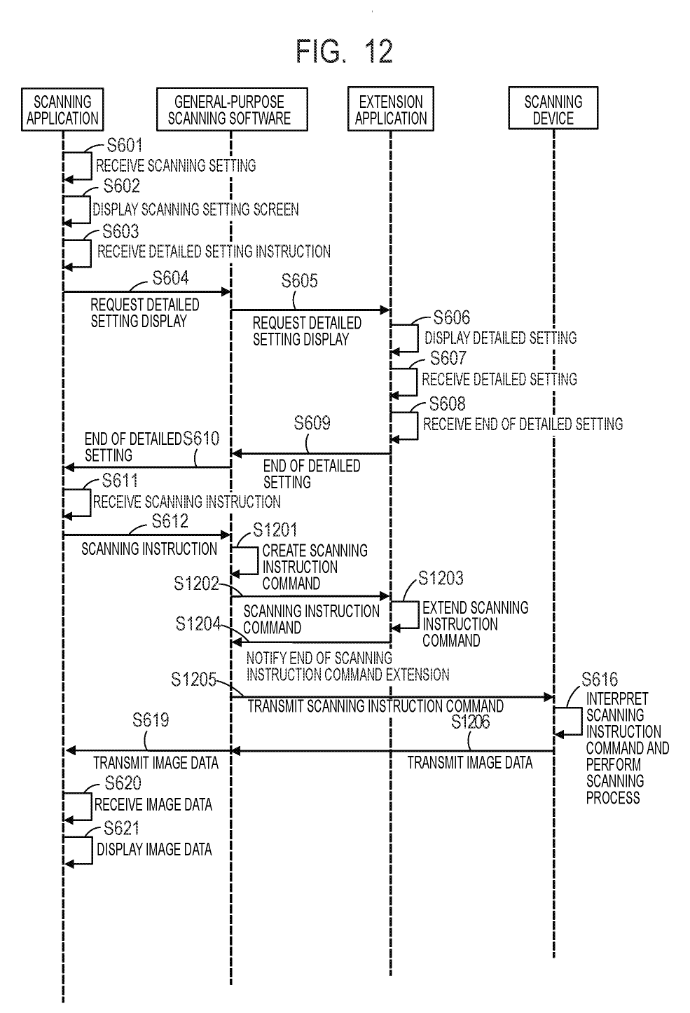

A sequence of the scanning application 201, the general-purpose scanning software 202, the extension application 204, and the scanning device 102 after the scanning application 201 receives the scanning setting will be described with reference to FIG. 12. Steps common to those in FIG. 6 will be denoted by the same reference numerals respectively, description thereof will be omitted, and differences will be mainly described. Each step other than the scanning device 102 in FIG. 12 is performed by the CPU 111 reading the scanning application 201, the general-purpose scanning software 202, and the extension application 204 from the external memory 114 to the RAM 113 and executing them. Each step of the scanning device 102 in FIG. 12 is realized by the CPU 191 of the scanning device 102 reading the program stored in the ROM 192 or the external memory 199 into the RAM 193 and executing the read program.

In S1201, the general-purpose scanning software 202 creates a scanning instruction command. At this time, a function not supported by the general-purpose scanning software 202 is not described in the scanning instruction command.

In S1202, the general-purpose scanning software 202 transfers the created scanning instruction command to the extension application 204.

In S1203, the extension application 204 adds an instruction command of a function not supported by the general-purpose scanning software 202 to the received scanning instruction command, changes the existing instruction, and extends the command. In the present embodiment, in S1201, since the background adjustment setting is not included in the scanning instruction command created by the general-purpose scanning software 202, the background adjustment setting is added.

In S1204, the extension application 204 transfers the extension scanning instruction command to the general-purpose scanning software 202.

In S1205, the general-purpose scanning software 202 transmits the scanning instruction command to the scanning device 102 to issue the scanning instruction.

In S1206, the general-purpose scanning software 202 receives the image data from the scanning device 102.

### Sequence of Scanning Process (Image Editing

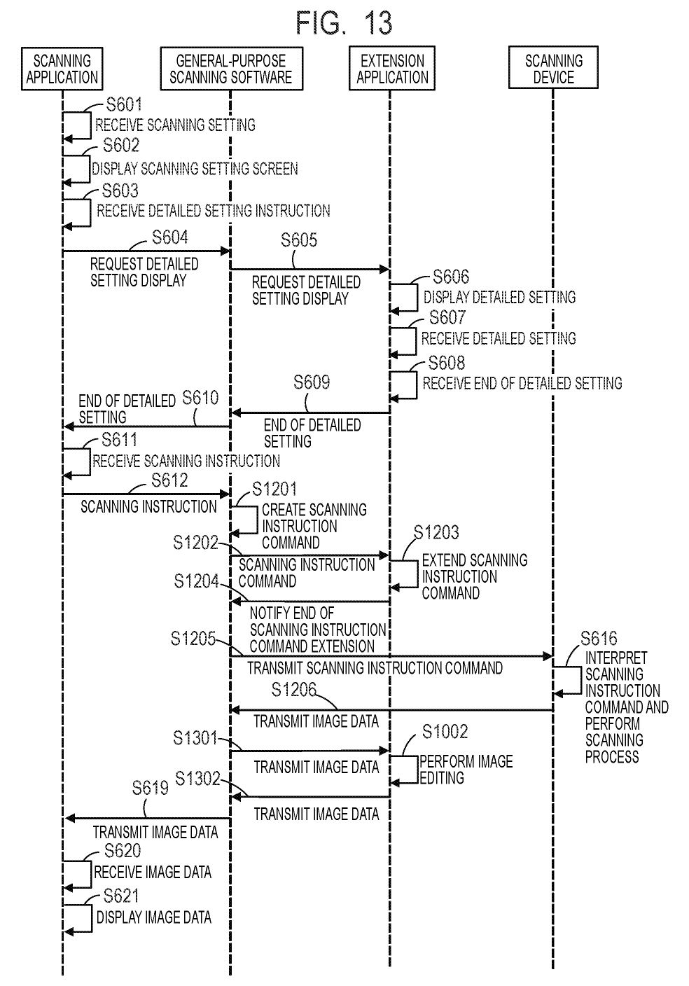

Next, with reference to FIG. 13, a sequence in a case where the image editing is performed by the extension application when the general-purpose scanning software 202 and the scanning device 102 exchange data with each other will be described. Steps common to those in FIG. 12 will be denoted by the same reference numerals respectively, description thereof will be omitted, and differences will be mainly described. Each step other than the scanning device 102 in FIG. 13 is performed by the CPU 111 reading the scanning application 201, the general-purpose scanning software 202, and the extension application 204 from the external memory 114 to the RAM 113 and executing them. Each step of the scanning device 102 in FIG. 13 is realized by the CPU 191 of the scanning device 102 reading the program stored in the ROM 192 or the external memory 199 into the RAM 193 and executing the read program.

In S1301, the general-purpose scanning software 202 transmits the received image data to the extension application 204.

In S1002, the extension application 204 performs the image editing. In the present embodiment, the image process for removing the ground color of the received image data is performed based on the background adjustment setting set in the same process as in S1104 of FIG. 11.

In S1302, the extension application 204 transmits the edited image data to the general-purpose scanning software 202.

As described above, in the present embodiment, the extension application 204 extends the background adjustment command thereby allowing the scanning device 102 to realize the background adjustment function, and the background adjustment function can be provided to the user.

### Embodiment 4

Hereinafter, an embodiment 4 of the present disclosure will be described. In the above embodiments 1 to 3, the commands used in the standard protocol are configured to be extended and exchanged with the scanning device 102.

In the embodiment 4, a configuration in which a command of the standard protocol is not extended, and a function supported only by the extension application 204 is exchanged with the scanning device 102 by another command will be described.

Hereinafter, only differences from the above-described embodiments will be described.

### Sequence of Scanning Process Another Command Transmission

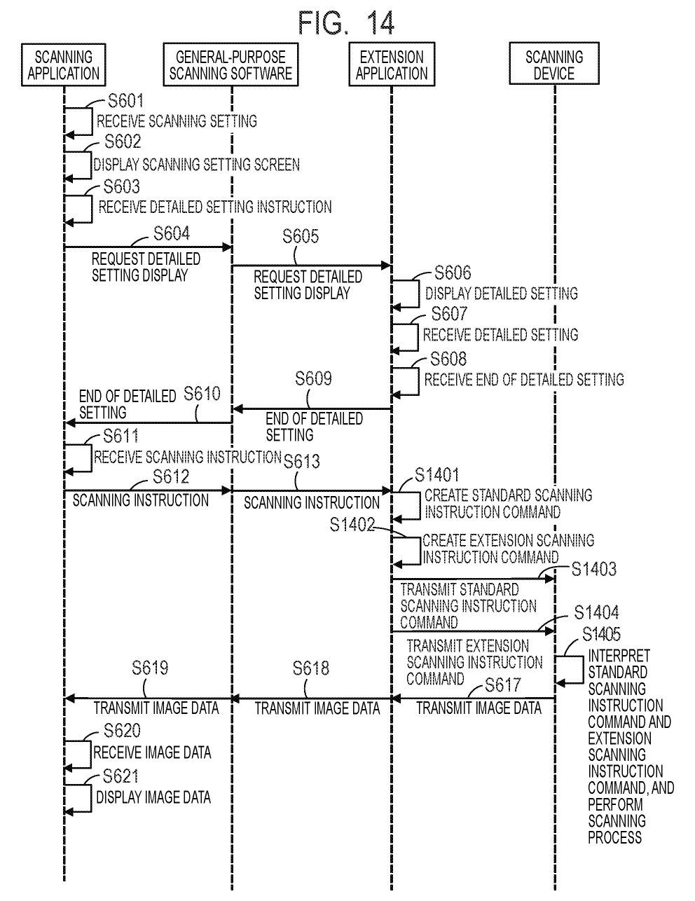

A sequence of the scanning application 201, the general-purpose scanning software 202, the extension application 204, and the scanning device 102 after the scanning application 201 receives the scanning setting will be described with reference to FIG. 14. Each step other than the scanning device 102 in FIG. 14 is performed by the CPU 111 reading the scanning application 201, the general-purpose scanning software 202, and the extension application 204 from the external memory 114 to the RAM 113 and executing them. Each step of the scanning device 102 in FIG. 14 is realized by the CPU 191 of the scanning device 102 reading the program stored in the ROM 192 or the external memory 199 into the RAM 193 and executing the read program. Steps common to those in FIG. 6 will be denoted by the same reference numerals respectively, description thereof will be omitted, and differences will be mainly described.

In S1401, the extension application 204 creates a standard scanning instruction command conforming to the standard protocol. At this time, a function not supported by the standard protocol is not described in the scanning instruction command.

In S1402, the extension application 204 creates an extension scanning instruction command for a function supported only by the extension application 204.

In S1403, the extension application 204 transmits the standard scanning instruction command to the scanning device 102 to issue the scanning instruction.

In S1404, the extension application 204 transmits the extension scanning instruction command to the scanning device 102 to issue the scanning instruction.

In S1405, the scanning device 102 interprets each of the received standard scanning instruction command and extension scanning instruction command, and executes the scanning process.

### Scanning Process: Extension Application

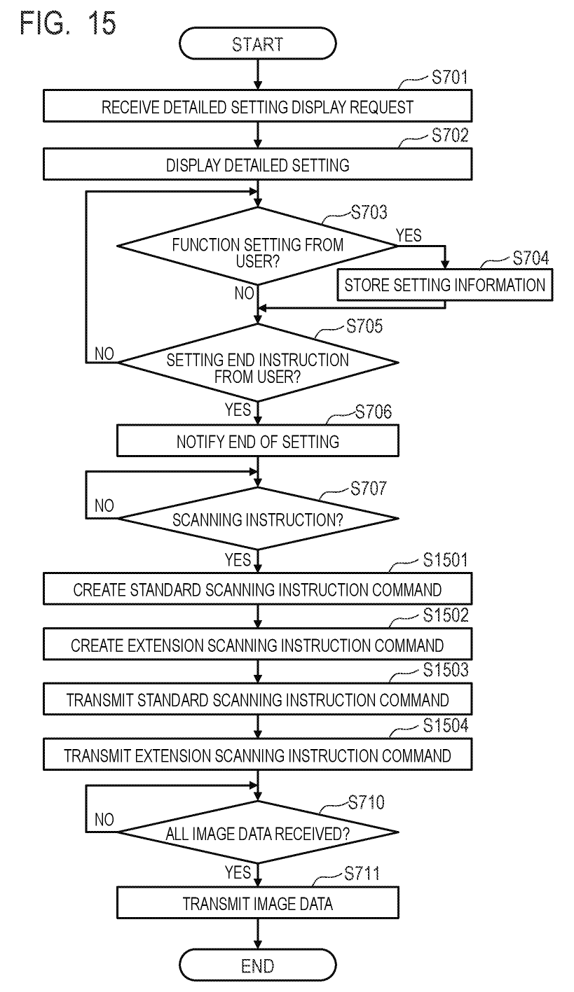

Here, a flow in which the extension application 204 executes the scanning process will be described with reference to FIG. 15. Each step is realized by the CPU 111 executing each unit read from the external memory 114 to the RAM 113. Steps common to those in FIG. 7 will be denoted by the same reference numerals respectively, description thereof will be omitted, and differences will be mainly described.

In S1501, the extension application 204 creates a standard scanning instruction command conforming to the standard protocol.

In S1502, the extension application 204 creates an extension scanning instruction command for a function that is not supported by the standard protocol.

In S1503, the extension application 204 transmits the standard scanning instruction command created in S1501 to the scanning device 102.

In S1504, the extension application 204 transmits the extension scanning instruction command created in S1502 to the scanning device 102.

As described above, in the embodiment 4, the background adjustment function can be provided to the user by transmitting another scanning instruction command in regard to the function not supported by the standard protocol from the extension application.

The disclosure of the present embodiments includes following storage media, method and configuration.

### Non-Transitory Computer-Readable Storage Medium 1

A non-transitory computer-readable storage medium that stores a program working with general-purpose scanning software commonly available in image reading apparatuses provided by a plurality of manufacturers, wherein, by executing the program, a computer causes an information processing apparatus to execute a method comprising: causing to display an object that receives a setting of creating image data in which a ground color of a document has been removed; and causing to output a reading instruction to the image reading apparatus that executes scanning, based on the setting received by the object.

### Non-Transitory Computer-Readable Storage Medium 2

The non-transitory computer-readable storage medium described in the non-transitory computer-readable storage medium 1, wherein the setting of creating the image data in which the ground color of the document has been removed is a setting of specifying a concentration of the ground color.

### Non-Transitory Computer-Readable Storage Medium 3

The non-transitory computer-readable storage medium described in the non-transitory computer-readable storage medium 2, wherein the setting of creating the image data in which the ground color of the document has been removed is a setting of specifying concentrations of a plurality of colors of the ground color.

### (Non-Transitory Computer-Readable Storage Medium 4)

The non-transitory computer-readable storage medium described in the non-transitory computer-readable storage medium 1, wherein the setting of creating the image data in which the ground color of the document has been removed is made by calculating a concentration of the ground color from the image data.

### Non-Transitory Computer-Readable Storage Medium 5

The non-transitory computer-readable storage medium described in the non-transitory computer-readable storage medium 1, wherein the method further comprises: determining whether or not a setting related to a type of the document received can be executed in the image reading apparatus; and in a case where it is determined that the setting related to the type of the document received cannot be executed, executing, on image data acquired by scanning, a process of creating the image data in which the ground color of the document has been removed, based on the received setting.

### Non-Transitory Computer-Readable Storage Medium 6

The non-transitory computer-readable storage medium described in the non-transitory computer-readable storage medium 5, wherein the method further comprises: determining whether or not the setting related to the type of the document received can be executed in the image reading apparatus; and in the case where it is determined that the setting related to the type of the document received cannot be executed, outputting an instruction command not including a function of creating the image data in which the ground color of the document has been removed to the image reading apparatus.

### Non-Transitory Computer-Readable Storage Medium 7

The non-transitory computer-readable storage medium described in the non-transitory computer-readable storage medium 1, wherein, when outputting the reading instruction to the image reading apparatus that executes the scanning, the method further comprises: transmitting an instruction command in which an instruction command of a standard protocol has been extended.

### Non-Transitory Computer-Readable Storage Medium 8

The non-transitory computer-readable storage medium described in the non-transitory computer-readable storage medium 1, wherein, when outputting the reading instruction to the image reading apparatus that executes the scanning, the method further comprises: transmitting an extended instruction command in addition to an instruction command of a standard protocol.

### Non-Transitory Computer-Readable Storage Medium 9

The non-transitory computer-readable storage medium described in the non-transitory computer-readable storage medium 1, wherein, when outputting the reading instruction to the image reading apparatus that executes the scanning, the method further comprises: transmitting a unique instruction command without transmitting a standard protocol.

### Method 1

A method of controlling an information processing apparatus that has a program working with general-purpose scanning software commonly available in image reading apparatuses provided by a plurality of manufacturers, the method comprising: causing to display an object that receives a setting of creating image data in which a ground color of a document has been removed; and outputting an instruction for executing reading of the document to the image reading apparatus that executes scanning, based on the setting received by the object.

### Configuration 1

An information processing apparatus that has a program working with general-purpose scanning software commonly available in image reading apparatuses provided by a plurality of manufacturers, the information processing apparatus comprising: at least one memory and at least one processor which function as: a displaying unit configured to display an object that receives a setting of creating image data in which a ground color of a document has been removed; and an outputting unit configured to output an instruction for executing reading of the document to the image reading apparatus that executes scanning, based on the setting received by the object.

### [Other Embodiments]

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-174485, filed October 3, 2024, which is hereby incorporated by reference herein in its entirety.

What is claimed is:

1. A non-transitory computer-readable storage medium storing a program working with general-purpose scanning software commonly available in image reading apparatuses provided by a plurality of manufacturers,
wherein, when executed by a computer, the program causes an information processing apparatus to perform a method comprising:
displaying an object that receives a setting of creating image data in which a ground color of a document has been removed; and
outputting a reading instruction to the image reading apparatus that executes scanning, based on the setting received by the object.

2. The non-transitory computer-readable storage medium according to claim 1, wherein the setting for creating the image data in which the ground color of the document has been removed includes specifying a concentration of the ground color.

3. The non-transitory computer-readable storage medium according to claim 2, wherein the setting of creating the image data in which the ground color of the document has been removed includes specifying concentrations of a plurality of colors of the ground color.

4. The non-transitory computer-readable storage medium according to claim 1, wherein the setting for creating the image data in which the ground color of the document has been removed is determined by calculating a concentration of the ground color from the image data.

5. The non-transitory computer-readable storage medium according to claim 1, wherein the method further comprises:
determining whether a setting related to a type of the document received is executable in the image reading apparatus; and
in response to determining that the setting related to the type of the document received is not executable, performing a process on image data acquired by scanning to create the image data in which the ground color of the document has been removed.

6. The non-transitory computer-readable storage medium according to claim 5, wherein the method further comprises:
determining whether the setting related to the type of the document received is executable in the image reading apparatus; and
in response to determining that the setting related to the type of the document received is not executable, outputting an instruction command that excludes a function for creating the image data in which the ground color of the document has been removed.

7. The non-transitory computer-readable storage medium according to claim 1, wherein outputting the reading instruction comprises transmitting an instruction command in which an instruction command of a standard protocol has been extended.

8. The non-transitory computer-readable storage medium according to claim 1, wherein outputting the reading instruction comprises transmitting an extended instruction command in addition to an instruction command of a standard protocol command.

9. The non-transitory computer-readable storage medium according to claim 1, wherein outputting the reading instruction comprises transmitting a unique instruction command without transmitting a standard protocol command.

10. A method of controlling an information processing apparatus that has a program working with general-purpose scanning software commonly available in image reading apparatuses provided by a plurality of manufacturers, the method comprising:
displaying an object that receives a setting of creating image data in which a ground color of a document has been removed; and
outputting an instruction for executing reading of the document to the image reading apparatus that executes scanning, based on the setting received by the object.

11. An information processing apparatus that has a program working with general-purpose scanning software commonly available in image reading apparatuses provided by a plurality of manufacturers, the information processing apparatus comprising:
at least one memory and at least one processor configured to:
display an object that receives a setting of creating image data in which a ground color of a document has been removed; and
output an instruction for executing reading of the document to the image reading apparatus that executes scanning, based on the setting received by the object.
